(19) United States
(12) Patent Application Publication
(10) Pub. No.: US 2015/0055368 A1
(43) Pub. Date: Feb. 26, 2015

(54) DISPLAY DEVICE

(71) Applicant: Wistron Corporation, New Taipei City (TW)

(72) Inventors: Yi-Hsuan Chu, New Taipei City (TW); Yung-Jan Chang, New Taipei City (TW); Chi-Wei Kuo, New Taipei City (TW); Hung-Te Chan, New Taipei City (TW); Yi-An Chen, New Taipei City (TW); Yi-Fan Chen, New Taipei City (TW); Kuan-Yu Chou, New Taipei City (TW); Chen-Hung Lin, New Taipei City (TW)

(73) Assignee: Wistron Corporation, New Taipei City (TW)

(21) Appl. No.: 14/044,877

(22) Filed: Oct. 3, 2013

(30) Foreign Application Priority Data
Aug. 26, 2013 (TW) 102130460

(51) Int. Cl. F21V 8/00

(52) U.S. Cl. CPC G02B 6/0031
USPC 362/609; 362/615; 362/627

(57) ABSTRACT

A display device includes a back cover, a front frame, a backlight module, and a display panel. The back cover has at least one supporting structure and at least one position-limiting structure. The front frame is assembled to the back cover. The backlight module is disposed between the back cover and the front frame and includes a light guide plate (LGP), and the supporting structure supports a bottom surface of the LGP. The display panel is disposed between the backlight module and the front frame, the position-limiting structure is aligned to a side surface of the display panel, and a position of the display panel is limited by the position-limiting structure.

### CROSS-REFERENCE TO RELATED APPLICATION

This application claims the priority benefit of Taiwan application serial no. 102130460, filed on Aug. 26, 2013. The entirety of the above-mentioned patent application is hereby incorporated by reference herein and made a part of this specification.

### BACKGROUND OF THE INVENTION

1. Field of the Invention

The invention relates to a display device. More particularly, the invention relates to a display device equipped with a display panel and a backlight module.

2. Description of Related Art

With advancement in the semiconductor industry and the relevant electronic industries, digital devices including smart phones, digital cameras, notebooks, flat panel televisions, and desktop computers have made progress to meet requirements for easy operation, multiple functionality, and attractive exterior design. Using said information products demands suitable display screens as indispensible man-machine interfaces, and the display screens of the aforementioned products facilitate various operations. Among the display screens, liquid crystal display (LCD) panels have become the mainstream products in the market. Since the LCD panel itself does not emit light, a backlight module acting as a light source must be placed under the LCD panel, so as to achieve the display function.

To be specific, in case that the display screen includes both the display panel and the backlight module, a mold frame is often configured between the back cover and the front frame of the display screen, so as to support the display panel and the light guide plate of the backlight module as well as limit the positions thereof. The mold frame, however, leads to an increase in the volume of the display screen and the width of the front frame, which does not comply with the design trend of compactness and slim border of the existing electronic devices.

### SUMMARY OF THE INVENTION

The invention provides a display device with the compact volume and the narrow front frame.

In an embodiment of the invention, a display device that includes a back cover, a front frame, a backlight module, and a display panel is provided. The back cover has at least one supporting structure and at least one position-limiting structure. The front frame is assembled to the back cover. The backlight module is disposed between the back cover and the front frame and includes a light guide plate (LGP), and the supporting structure supports a bottom surface of the LGP. The display panel is disposed between the backlight module and the front frame, the position-limiting structure is aligned to a side surface of the display panel, and a position of the display panel is limited by the position-limiting structure.

According to an embodiment of the invention, the bottom surface of the LGP is perpendicular to the side surface of the display panel.

According to an embodiment of the invention, the supporting structure and the position-limiting structure are connected.

According to an embodiment of the invention, the back cover has a bottom plate and a sidewall, the supporting structure is connected to the bottom plate, and the position-limiting structure is connected between the supporting structure and the sidewall.

According to an embodiment of the invention, the supporting structure and the position-limiting structure are separated.

According to an embodiment of the invention, the supporting structure includes two supporting portions and one holding portion. The two supporting portions are extended along a direction perpendicular to the bottom surface of the LGP, the holding portion is connected between the two supporting portions and extended along a direction parallel to the bottom surface of the LGP, and the LGP is held by the holding portion.

According to an embodiment of the invention, the display device further includes a supporting member between the LGP and the display panel, such that a gap exists between the LGP and the display panel.

According to an embodiment of the invention, the backlight module further includes an optical film set disposed on the LGP and in the gap.

According to an embodiment of the invention, the backlight module further includes a reflector disposed between the back cover and the LGP.

According to an embodiment of the invention, an end of the reflector is located between the supporting structure and the bottom surface of the LGP.

In view of the above, the back cover of the display device has the supporting structure and the position-limiting structure respectively for supporting the LGP of the backlight module and limiting the position of the display panel. Hence, it is not necessary to additionally set any mold frame in the display device to support the LGP and limit the position of the display panel, and thus the conventional issue (i.e., the volume of the display device and the width of the front frame are increased because of the mold frame) can be resolved, so as to comply with the design trend of compactness and slim border of the electronic device.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic three-dimensional view illustrating a display apparatus according to an embodiment of the invention.

FIG. 2 is an exploded view illustrating some components in the display device depicted in FIG. 1.

FIG. 3 is an enlarged view illustrating a region A in the back cover depicted in FIG. 2.

FIG. 4 is a schematic view illustrating that the back cover shown in FIG. 3 holds the LGP and the display panel depicted in FIG. 2.

FIG. 5 is a cross-sectional view illustrating the display device shown in FIG. 1 along a line I-I.

FIG. 6 is an enlarged view illustrating a region B in the back cover depicted in FIG. 2.

FIG. 7 is a cross-sectional view illustrating the electronic device shown in FIG. 1 along a line II-II.

### DETAILED DESCRIPTION OF DISCLOSED EMBODIMENTS

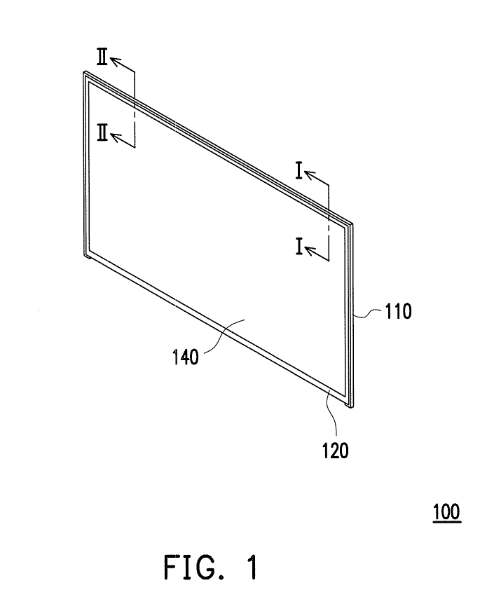

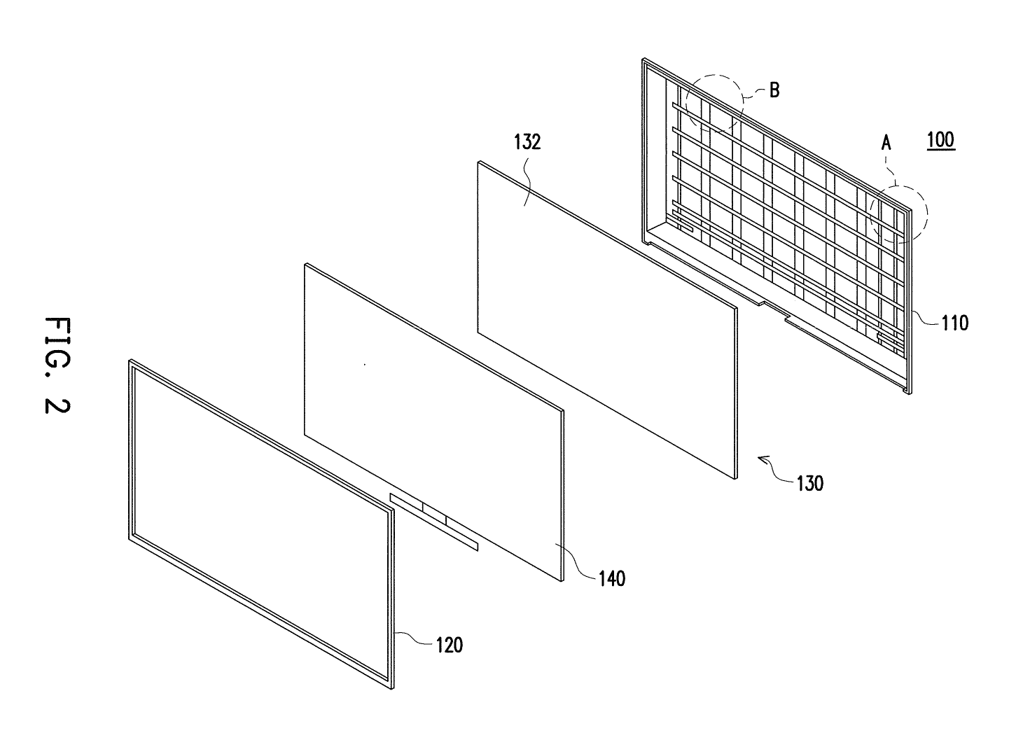

FIG. 1 is a schematic three-dimensional view illustrating a display apparatus according to an embodiment of the invention. FIG. 2 is an exploded view illustrating some components in the display device depicted in FIG. 1. With reference to FIG. 1 and FIG. 2, the display device 100 described in the present embodiment includes a back cover 110, a front frame 120, a backlight module 130, and a display panel 140. The front frame 120 is assembled to the back cover 110, and the backlight module 130 is disposed between the back cover 110 and the front frame 120 and includes a light guide plate (LGP) 132. The display panel 140 is, for instance, a liquid crystal display (LCD) panel and is disposed between the backlight module 130 and the front frame 120.

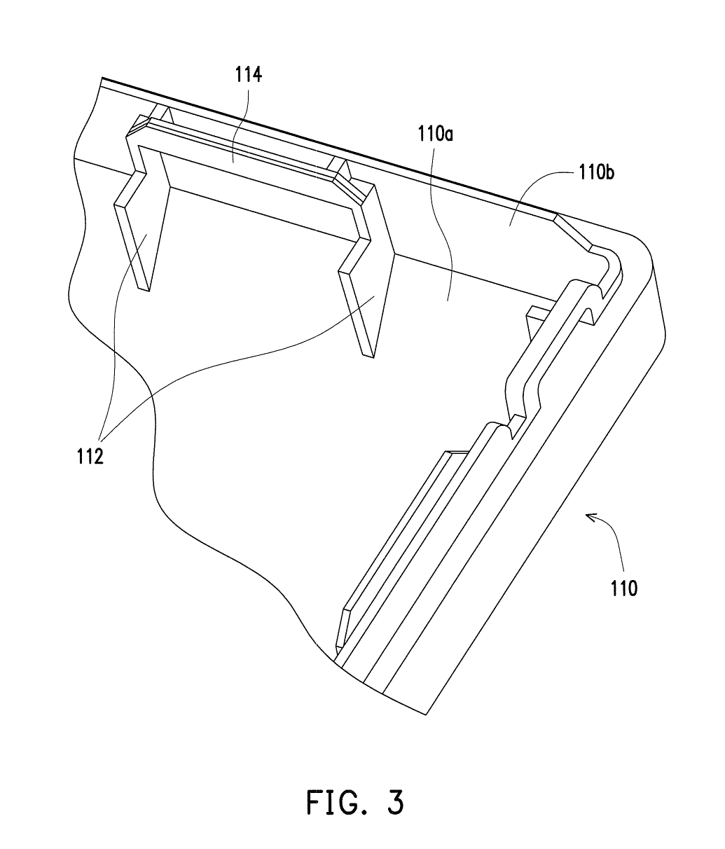

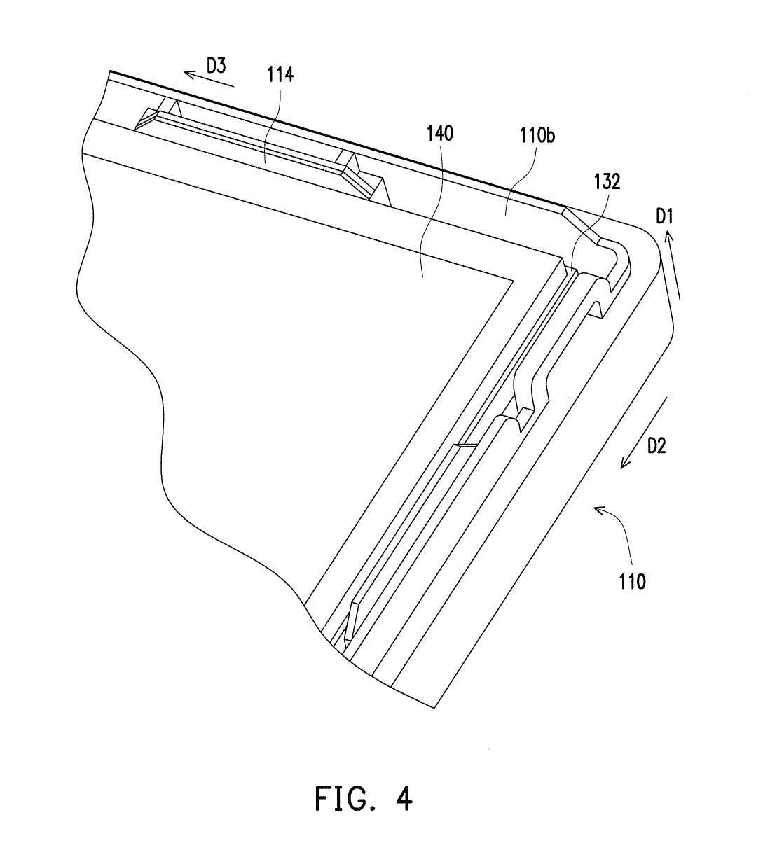

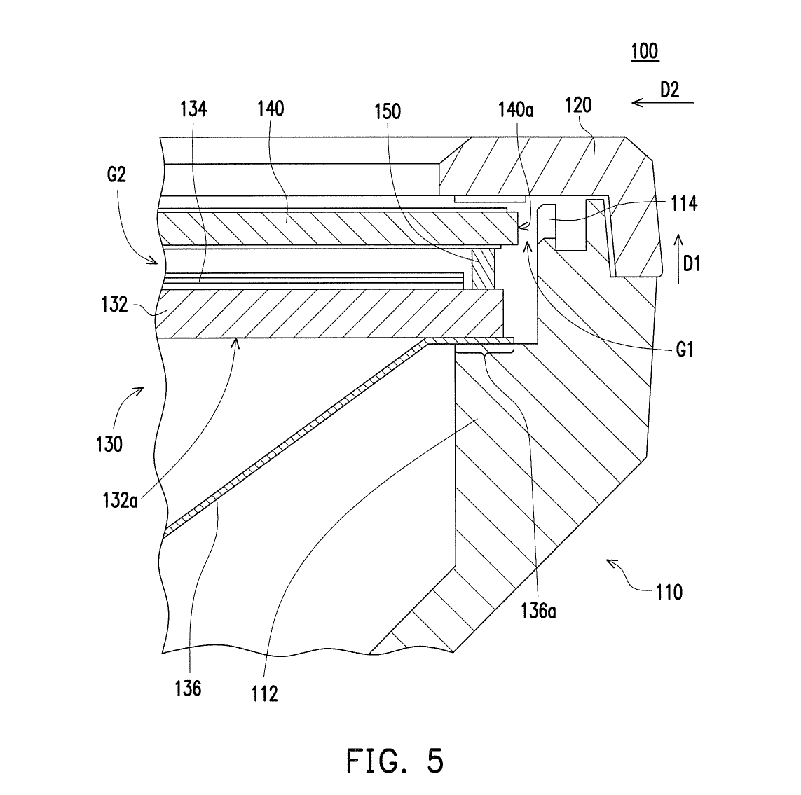

FIG. 3 is an enlarged view illustrating a region A in the back cover depicted in FIG. 2. FIG. 4 is a schematic view illustrating that the back cover shown in FIG. 3 holds the LGP and the display panel depicted in FIG. 2. FIG. 5 is a cross-sectional view illustrating the display device shown in FIG. 1 along a line I-I. With reference to FIG. 3 to FIG. 5, the back cover 110 has a supporting structure 112 and a position-limiting structure 114. The supporting structure 112 supports a bottom surface 132a of the LGP 132, and the position-limiting structure 114 is aligned to a side surface 140a of the display panel 140 and limits a position of the display panel 140. As described above, the back cover 110 has the supporting structure 112 for supporting the LGP 132 and the position-limiting structure 114 for limiting the position of the display panel 140, and it is not required to additionally set a mold frame onto the display device 100 to support the LGP 132 and limit the position of the display panel 140. Thereby, the conventional issue (i.e., the volume of the display device 100 and the width of the front frame 120 are increased because of the mold frame) can be resolved, so as to comply with the design trend of compactness and slim border of the electronic device.

Particularly, if the mold frame is placed between the back cover 110 and the front frame 120 of the display device 100, the mold frame has the thickness in the directions D1, D2, and D3 shown in FIG. 4, and thus the volume of the entire structure is increased. Besides, the width of the front frame 120 along the directions D2 and D3 is also correspondingly increased, which is not conducive to the slim border design. As described above, the supporting structure 112 and the position-limiting structure 114 of the back cover 110 replace the mold frame, so as to prevent the mold frame from increasing the volume of the overall structure and the width of the front frame.

With reference to FIG. 5, in the present embodiment, the bottom surface 132a of the LGP 132 is perpendicular to the side surface 140a of the display panel 140. The supporting structure 112 supports the LGP 132 along the direction D1. The front frame 120 limits the display panel 140 and the LGP 132 to be located on the supporting structure 112, and the position-limiting structure 114 limits the position of the display panel 140 along the direction D2 perpendicular to the direction D1, so as to fix the LGP 132 and the display panel 140 between the front frame 120 and the back cover 110. In addition, the gap G1 may be reserved between the position-limiting structure 114 and the side surface 140a of the display panel 140, so as to prevent the display panel 140 from being warped due to thermal expansion.

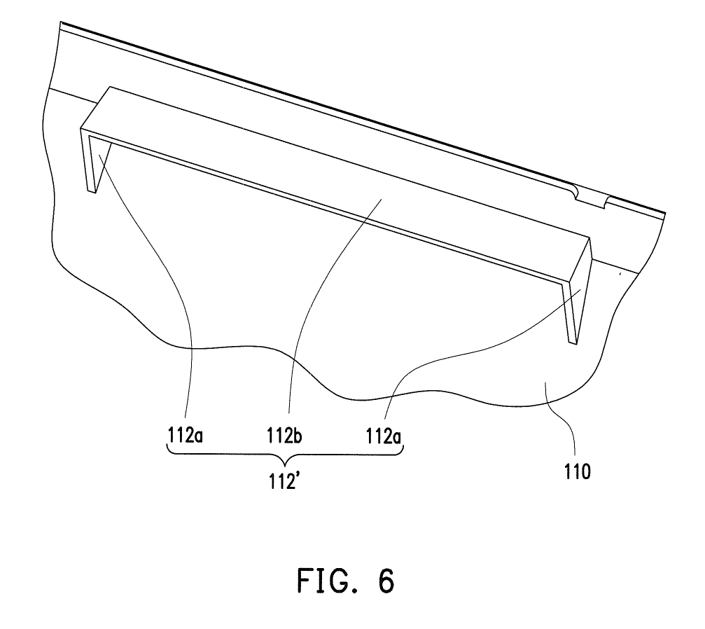

In the present embodiment, the back cover 110 not only has the supporting structure 112 and the position-limiting structure 114 shown in FIG. 3 but also has the supporting structure 112′ shown in FIG. 6, and it is likely for the back cover to have more supporting structures and more position-limiting structures, so as to support the LGP 132 and the display panel 140 and limit the positions thereof. The number of the supporting structures and the position-limiting structures is not limited in the invention.

With reference to FIG. 3, in the present embodiment, the supporting structure 112 and the position-limiting structure 114 described herein are designed to be connected to each other. Specifically, the supporting structure 112 is connected to the bottom plate 110a of the back cover 110, and the position-limiting structure 114 is connected between the supporting structure 112 and the sidewall 110b of the back cover 110. The type/form of the supporting structure should not be construed as a limitation to the invention and will be elaborated hereinafter with reference to the drawings.

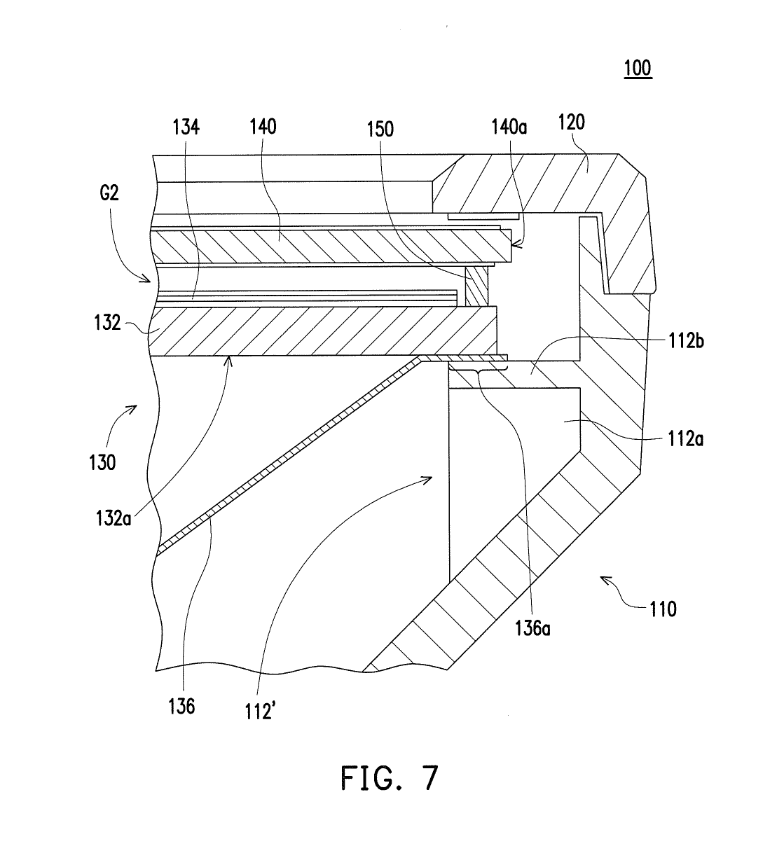

FIG. 6 is an enlarged view illustrating a region B in the back cover depicted in FIG. 2. FIG. 7 is a cross-sectional view illustrating the electronic device shown in FIG. 1 along a line II-II. With reference to FIG. 6 and FIG. 7, the back cover 110 has another supporting structure 112′. Similar to the supporting structure 112 depicted in FIG. 3 to FIG. 5, the supporting structure 112′ may also support the LGP 132, and the supporting structure 112′ and the position-limiting structure 114 shown in FIG. 3 are designed to be separated from each other. Specifically, the supporting structure includes two supporting portions 112a and one holding portion 112b, and the holding portion 112b is connected between the two supporting portions 112a and holds the LGP 132.

With reference to FIG. 5, the display device 100 described herein may further include a supporting member 150. The supporting member 150 is made of rubber and is between the LGP 132 and the display panel 140, such that a gap G2 exists between the LGP 132 and the display panel 140. The backlight module 130 further includes an optical film set 134 and a reflector 136. The optical film set 134 is disposed on the LGP 132 and located in the gap G2 between the LGP 132 and the display panel 140. The reflector 136 is disposed between the back cover 110 and the LGP 132, so as to reflect the light from the light source to the LGP 132. Here, the light source is disposed on the bottom plate 110a of the back cover 110, as shown in FIG. 3, and the light source faces the LGP 132, for instance. In the present embodiment, the reflector 136 is extended onto the supporting structure 112, such that an end 136a of the reflector 136 is located between the supporting structure 112 and the bottom surface 132a of the LGP 132. In another embodiment, the reflector 136 may not be extended to the space between the supporting structure 112 and the LGP 132, which should not be construed as a limitation to the invention.

To sum up, the back cover of the display device described herein has the supporting structure for supporting the LGP and the position-limiting structure for limiting the position of the display panel, and it is not required to additionally set a mold frame onto the display device to support the LGP and limit the position of the display panel. Thereby, the conventional issue (i.e., the volume of the display device and the width of the front frame are increased because of the mold frame) can be resolved, so as to comply with the design trend of compactness and slim border of the electronic device.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A display device comprising:
a back cover having at least one supporting structure and at least one position-limiting structure;
a front frame assembled to the back cover;
a backlight module disposed between the back cover and the front frame, the backlight module comprising a light guide plate, the at least one supporting structure supporting a bottom surface of the light guide plate; and
a display panel disposed between the backlight module and the front frame, the at least one position-limiting structure being aligned to a side surface of the display panel, a position of the display panel being limited by the at least one position-limiting structure.

2. The display device as recited in claim 1, wherein the bottom surface of the light guide plate is perpendicular to the side surface of the display panel.

3. The display device as recited in claim 1, wherein the at least one supporting structure and the at least one position-limiting structure are connected.

4. The display device as recited in claim 3, wherein the back cover has a bottom plate and a sidewall, the at least one supporting structure is connected to the bottom plate, and the at least one position-limiting structure is connected between the at least one supporting structure and the sidewall.

5. The display device as recited in claim 1, wherein the at least one supporting structure and the at least one position-limiting structure are separated.

6. The display device as recited in claim 1, wherein the at least one supporting structure comprises two supporting portions and one holding portion, the two supporting portions are extended along a direction perpendicular to the bottom surface of the light guide plate, the holding portion is connected between the two supporting portions and extended along a direction parallel to the bottom surface of the light guide plate, and the light guide plate is held by the holding portion.

7. The display device as recited in claim 1, further comprising a supporting member between the light guide plate and the display panel, such that a gap exists between the light guide plate and the display panel.

8. The display device as recited in claim 7, wherein the backlight module further comprises an optical film set disposed on the light guide plate and in the gap.

9. The display device as recited in claim 1, wherein the backlight module further comprises a reflector disposed between the back cover and the light guide plate.

10. The display device as recited in claim 9, wherein an end of the reflector is located between the at least one supporting structure and the bottom surface of the light guide plate.
